(19) United States
(12) Patent Application Publication
(10) Pub. No.: US 2003/0206350 A1
(43) Pub. Date: Nov. 6, 2003

(54) Low-order aberration correction using articulated optical element

(76) Inventors: Robert W. Byren, Hermosa, CA (US); Lacy G. Cook, El Segundo, CA (US); William S. Griffin, Manhattan Beach, CA (US)

Correspondence Address: PATENT DOCKET ADMINISTRATION, RAYTHEON SYSTEMS COMPANY, P.O. BOX 902 (E1/E150), BLDG E1 M S E150, EL SEGUNDO, CA, 90245-0902, US

(21) Appl. No.: 10/139,969

(22) Filed: May 6, 2002

(51) Int. Cl. G02B 27/00; G02B 3/02; G02B 13/18

(52) U.S. Cl. 359/613; 359/708

(57) ABSTRACT

A system (200) for effecting low-order aberration correction of a beam of electromagnetic energy. The inventive system (200) includes a first mechanism (220), including at least one articulated optical element (222), for receiving and correcting the beam; a second mechanism (270) for generating a signal indicative of the aberrations to be corrected; and a third mechanism (226), responsive to the second mechanism (270), for adjusting the position of the optical element (222) to generate an output beam that is at least partially compensated with respect to the aberrations. In the preferred embodiment, the first mechanism (220) is a telescope comprising a fixed primary lens or mirror (224) and an articulated secondary lens or mirror (222). The second mechanism (270) includes a wavefront error sensor for detecting aberrations in the received beam. The third mechanism includes a processor (320) responsive to the second mechanism (270) for providing a correction signal, and six linear actuator struts (226) arranged in a non-redundant hexapod configuration to move the secondary lens or mirror (222) in at least five degrees-of-freedom in response to the correction signal.

### BACKGROUND OF THE INVENTION

1. Field of the Invention

The present invention relates to optics. More specifically, the present invention relates to systems and methods for correcting high-power beams of electromagnetic energy.

2. Description of the Related Art

High power lasers are being considered for a variety of industrial, commercial, and military applications, including materials processing, satellite imaging, target tracking and identification, and directed energy weapons (DEW). Laser DEW systems generally involve the use of a high energy laser (HEL) to irradiate and destroy a target. To achieve performance objectives, many of these applications require that the laser beam be accurately steered and optimally focused. Steering involves line-of-sight control while focusing involves wavefront error correction.

Atmospheric turbulence produces density variations in the air that cause optical pathlength differences across a given beam path. The result is an optical distortion (or aberration) that reduces the average intensity of a focused laser beam due to beam spreading and causes spatial and temporal fluctuations in the beam due to scintillation. For many high power laser applications, it is advantageous to correct for the turbulence-induced aberration by pre-distorting the laser beam with the phase conjugate of the pathlength-integrated phase distortion (optical pathlength difference).

Traditional laser beam control adaptive optic (AO) systems use one or more multi-actuator deformable mirrors (DMs) in the beam path to correct for the wavefront aberrations caused by atmospheric turbulence. The conventional deformable mirror is typically a large element with a thin face sheet and a number of piezoelectric actuators. Actuators are located behind the face sheet and are electrically driven to push and pull on the surface thereof to effect the deformation required to correct wavefront errors in an outgoing beam.

Astronomical telescopes routinely use DMs for atmospheric correction. Deformable mirrors provide good low and high order correction. Two deformable mirrors may be employed in the same beam path to correct for the large-stroke, low-bandwidth and the small-stroke, wide-bandwidth errors, respectively (woofer/tweeter arrangement).

However, deformable mirrors are difficult and expensive to manufacture and require a high throughput processor, called a real-time reconstructor. The real-time reconstructor is needed to calculate the actuator commands required to properly shape the mirror facesheet for optimal wavefront correction.

Hence, a need exists in the art for an improved system or method for effecting aberration correction of a high power laser beam which is less expensive and less complex than conventional approaches.

### SUMMARY OF THE INVENTION

The need in the art is addressed by the system and method for effecting low-order aberration correction of a beam of electromagnetic energy of the present invention. The inventive system includes a first mechanism, including at least one articulated optical element, for receiving and correcting the beam; a second mechanism for generating a signal indicative of the aberrations to be corrected; and a third mechanism, responsive to the second mechanism, for adjusting the position of the optical element in piston, translation, and tilt to generate an output beam that is at least partially compensated with respect to the aberrations. This approach provides focus, coma, and to a lesser extent astigmatism correction of the beam.

In the preferred embodiment, the first mechanism is a telescope comprising a fixed primary lens and an articulated secondary lens. The second mechanism includes a wavefront error sensor for detecting aberrations in the received beam and adapted to provide a wavefront error signal in response thereto. The third mechanism includes a processor, responsive to the wavefront error signal, for providing a correction signal, and six linear actuator struts arranged in a non-redundant hexapod configuration to maneuver the secondary lens in at least five degrees-of-freedom (axial displace, two tilts, and two decenters) in response to the correction signal.

### BRIEF DESCRIPTION OF THE DRAWINGS

FIG. 1 is a simplified optical schematic of a conventional laser beam control architecture.

FIG. 2 is a graph showing the Strehl ratio of a laser beam propagating through the atmosphere as a function of D/r₀ for perfect phase-only adaptive optics and varying degrees of low-order adaptive optic correction.

FIG. 3 is an optical schematic of an illustrative embodiment of a beam control architecture in accordance with the teachings of the present invention.

FIG. 4 is a 3-D solid model representation of the beam director gimbal system in accordance with the teachings of the present invention.

FIG. 5 is a cut away view of the beam director gimbal showing the optical elements along the beam path, including an articulated secondary lens element in accordance with the teachings of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

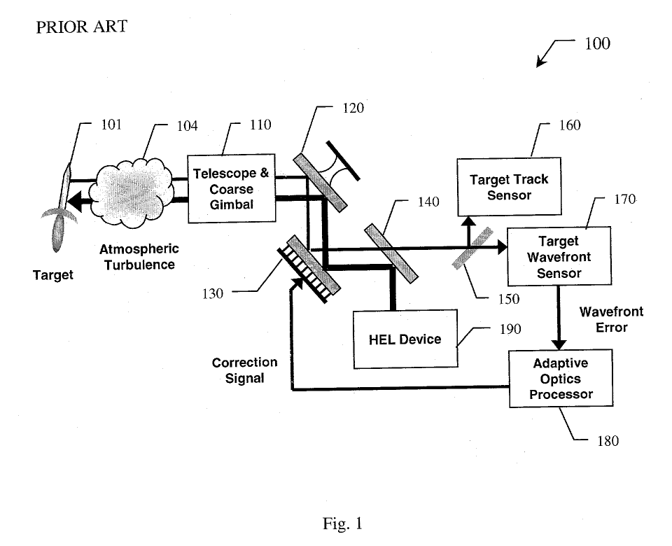

A simplified optical schematic of a conventional laser beam control architecture 100 is shown in FIG. 1. A beam director, generally consisting of a Telescope and 2-axis Coarse Gimbal 110, is commanded to the line-of-sight of a Target 101 based on an external cue (acquisition or coarse tracking system not shown). A Target Track Sensor 160 acquires the target and begins to close a track servo loop (not shown) maintaining line-of-sight to the target 101. Optical aberrations along the line-of-sight caused by atmospheric turbulence 104 along the path to the target 101 distort the image of the target 101, causing relatively poor tracking performance. The Target Wavefront Sensor 170 measures this wavefront (or phase) distortion, and an Adaptive Optics Processor 180, which includes a high throughput real-time reconstructor, closes an adaptive optics servo loop around a Deformable Mirror (DM) 130, effectively nulling the wavefront (or phasefront) error caused by the atmosphere. The Target Wavefront Sensor 170 can employ an active sensor with a beacon illuminator (not shown) to measure either subaperture tilts (Shack-Hartmann sensor) or optical phase (lateral shearing interferometer or transform wavefront sensor). The Target Wavefront Sensor 170 can also employ imaging sensors at different focal positions to infer phase from the passive target imagery using “phase diversity” techniques. The AO loop corrects the aberrations along the target path allowing the tracker to operate at full performance. It also corrects the portion of the beam path for the Laser Device 190 from the Aperture Sharing Element (ASE) 140 to the Target 101, enabling high instantaneous beam intensity (high Strehl ratio) and low beam wander (low angular jitter) on the target 101.

Fast Steering Mirrors 120 may be used in conjunction with a stable platform and internal active auto-alignment system (not shown) to provide wide bandwidth correction for line-of-sight disturbances caused by imperfect isolation of base motion, structural compliance, gimbal bearing runout, and gimbal axis non-orthogonality. The Fast Steering Mirror 120 can also be used to off-load high frequency tilt corrections from the DM 130, thereby minimizing the stroke requirement of the DM actuators.

The theory of operation and description of key components for a conventional HEL beam control system may be found in several published references, including:

1. Tyson and Ulrich, “Adaptive Optics”, The Infrared and Electro-Optical Handbook, Volume 8, Chapter 2, ERIM, Ann Arbor, Mich., pp. 165-237, (1993) and

2. Golnik, “Directed Energy Systems”, The Infrared and Electro-Optical Handbook, Volume 8, Chapter 5, ERIM, Ann Arbor, Mich., pp. 403-480, (1993).

This conventional approach suffers from several limitations. In particular, while deformable mirrors provide good low and high order correction, they are difficult and expensive to manufacture, and they require a high throughput processor, called a real-time reconstructor, to calculate the actuator commands that properly shape the mirror facesheet for best wavefront correction.

In many applications it may not be necessary to correct for both low and high order aberrations. For instance, one anticipated application is primarily addressing barrage artillery attacks of hundreds of mortars and tactical rockets which must be engaged at high look-up angles, where the atmospheric turbulence induced wavefront errors are primarily low order. For such applications, a low cost, low-order aberration control system may be preferable to a full high-order adaptive optics system with expensive deformable mirrors and real-time reconstructor elements. Low-order correction would be particularly effective when used with the diode-pumped solid state heat capacity laser (HCL) due to the presence of uncorrectable high-order wavefront errors in the raw beam.

The present invention obviates the need for the deformable mirror and associated real-time reconstructor processor. It performs low-order wavefront correction, for example, by articulating the secondary mirror of the beam director telescope in 5 degrees-of-freedom using a hexapod arrangement of linear actuators. This approach provides focus, coma, and to a lesser extent astigmatism correction of the HEL beam, which are the primary aberrations anticipated in future demanding applications. This approach is well suited to one anticipated application which uses an adaptive optic system internal to the resonant cavity of a high power solid-state heat capacity laser (HCL) to enhance the beam quality of the raw high power beam. The design and theory of operation of the HCL is described more fully by Albrecht, et al in U.S. Pat. No. 5,526,372, dated Jun. 11, 1996, entitled “High Energy Bursts from a Solid State Laser Operated in the Heat Capacity Limited Regime”. This intracavity adaptive optic system is expected to provide adequate correction for the low-order terms but not for the high-order terms. Due to the high-order aberrations inherent in the raw HCL beam, external high-order atmospheric correction would not be very effective in increasing the beam intensity on target. A high-order adaptive optic solution employing DMs and complex reconstructors may be too expensive for certain missions and is not a good match to the performance requirement and HCL raw laser beam quality.

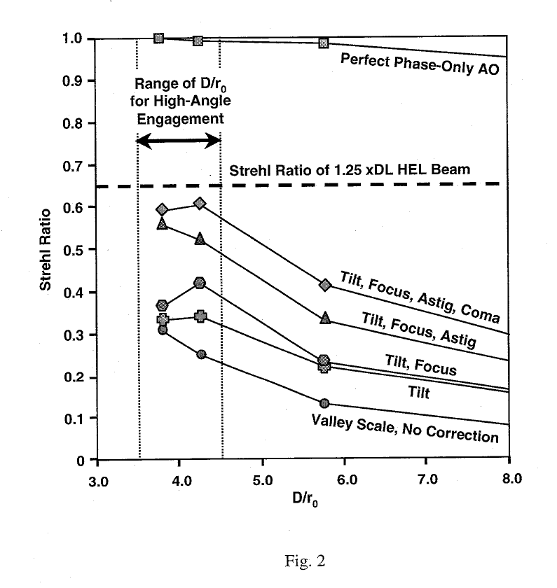

FIG. 2 is a graph showing Strehl ratio as a function of D/r₀ for perfect phase-only adaptive optics and varying degrees of low-order adaptive optic correction. The D/r₀ term is a dimensionless parameter that is the ratio of beam director exit aperture (D) to the lateral correlation length (r₀), which is indicative of the strength of atmospheric distortion that must be corrected for a given beam control system. The region of interest for tactical applications is shown between the vertical dashed lines, corresponding to D/r₀ values between 3.5 and 4.5.

Low-order correction is particularly attractive when combined with a locally-corrected HEL beam employing low-order adaptive optics. The Strehl ratio associated with an HEL beam with a raw beam quality that is 1.25 times the diffraction limit, assuming zero atmospheric turbulence, is shown as a horizontal dashed line on the graph in FIG. 2 to indicate the performance limit for such a laser. Note that the Strehl ratio for a perfect raw beam that is corrected for atmospheric tilt, focus, astigmatism, and coma is of the same order as the Strehl ratio for a 1.25×DL raw HEL beam, indicating that a higher-order correction for such a beam may produce diminishing returns.

The intracavity AO correction scheme presently being used in the heat capacity laser for local-loop beam cleanup is expected to provide best correction of the low-order wavefront errors in the raw HEL beam thereby enhancing the effectiveness of low-order target-loop correction. Conversely, the intrinsic, uncompensated higher order aberrations in the HEL beam would dominate (and thereby diminish the effectiveness of) the high-order corrections that a full-AO target loop approach would apply, the result being less than ideal correction and reduced Strehl. Furthermore, a full-AO target loop correction approach based on active beacon illumination, sub-aperture tilt sensing using Shack-Hartmann arrays, matrix-multiply real-time reconstruction, and high order deformable mirror correction would be very expensive and may be very difficult to support in the stressing tactical battlefield environment.

The objective for this invention is a more straightforward adaptive optics approach that meets the performance needs of anticipated mission requirements, is supportable in the field, and is compatible with the constraints imposed by the heat capacity laser device, particularly the wavefront quality of the raw HEL beam. An objective of the present invention is to take maximum advantage of the hardware elements, which are essential to the basic pointing and tracking functions, in implementing the high bandwidth jitter control and wavefront correction performance enhancements. These elements include a coarse 2-axis gimbal with hyper-hemispherical coverage; position, rate, and inertial sensors; high-speed full-aperture image trackers; digital image processors using commercial off-the-shelf (COTS) digital signal processors; conventional telescope optics; and wide-bandwidth Coudé-path beam steering mirrors.

The idea of tilting refractive lens elements to produce astigmatism and other low-order optical aberrations is known in the art. For example, in U.S. Pat. No. 5,228,051, Matthews describes a method and apparatus for relay imaging between successive amplifier stages in a high peak power (e.g., Q-switched) laser master oscillator/power amplifier (MOPA) architecture without causing laser-induced air breakdown. This approach tilts the first imaging lens sufficiently to cause a distortion at the focus, thereby lowering the peak field intensity below the threshold for air breakdown. The second recollimating lens is tilted by a comparable amount to correct for the distortion, producing a beam that is relatively free of astigmatism. For phase conjugate MOPA configurations, this is important because straightforward phase conjugate mirrors are less able to compensate for astigmatism than other types of aberrations.

Raytheon has pioneered the use of dynamic compensating elements to correct for low-order figure errors in conformal windows used with missile seekers and high performance aircraft electro-optical sensors. As in the present invention, these methods employ articulated optical elements for modal correction. The motion of these elements is preprogrammed as a function of look angle through the conformal window and therefore operate open-loop. An early dynamic aberration corrector, described by Kunick, Chen, Cook, and Lau (U.S. Pat. No. 5,526,181) uses a one-dimensional corrector plate for providing a varying amount of linear coma and a pair of cylindrical lenses for providing a varying amount of astigmatism to dynamically correct the low order optical aberrations created by a conformal window. A more advanced design, described by Morgan and Cook (U.S. Pat. No. 6,018,424), uses the inner surface of the conformal window to compensate for the higher-order aberrations and a single articulated aberration generator to compensate the lower-order aberrations, notably focus and astigmatism, over the field of regard.

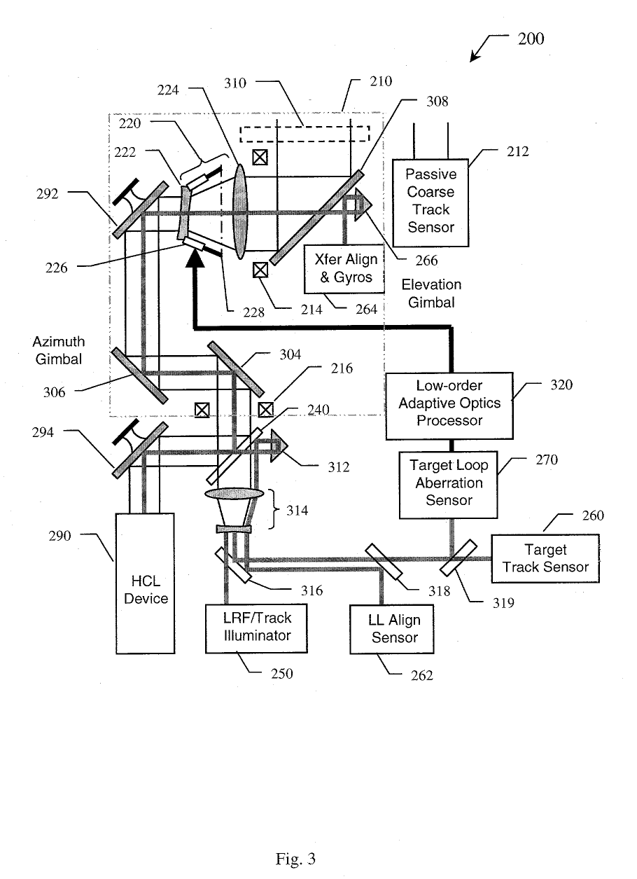

The optical aberrations produced by translating a lens element longitudinally (focus) and laterally (tilt/coma) as well as tipping the element (coma/astigmatism) are well-known and readily modeled using physical optics codes. The present invention seeks to apply this optical design knowledge in a novel way to correct for atmospheric-turbulence induced low-order aberrations in a high energy laser beam control system. An optical schematic of this inventive beam control architecture is shown in FIG. 3.

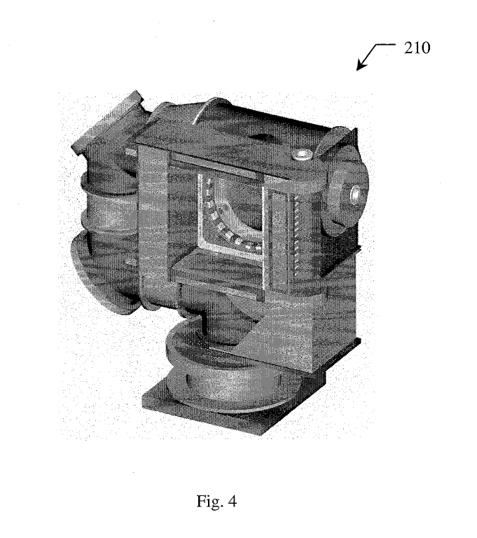

FIG. 3 is an optical schematic of an illustrative embodiment of the beam control architecture 200 of the present invention. A 3-D solid model representation of the beam director gimbal system 210 is also shown in FIG. 4. The inventive beam control architecture 200 employs many of the same features as the conventional beam control architecture described above. A HEL beam director 210 (coelostat configuration shown in FIG. 3 as an example) is commanded to the line-of-sight of a target based on an external cue from a Passive Coarse Track Sensor 212. The beam director 210 includes a Telescope 220 and a 2-axis Coarse Gimbal. Elements located to the right of the Elevation Gimbal Bearings 214 are situated on the Elevation Gimbal, while elements located above the Azimuth Gimbal Bearings 216 are situated on the Azimuth Gimbal. An active target tracking system including a Laser Range Finder (LRF) and Track Illuminator 250 and a Target Track Sensor 260 maintains the line-of-sight on the target. The illustrative embodiment also includes a Local Loop (LL) Alignment Sensor 262 and Transfer Alignment System 264 to correct for misalignment errors. A Target Loop Aberration Sensor 270 measures the low-order wavefront errors caused by the atmospheric aberrations.

The Beam Director Telescope 220 expands the raw HEL beam from a High Energy Laser Device 290. The Aperture Sharing Element (ASE) 240 allows a single shared aperture to be advantageously used for both the low power sensors and the high power output laser beam, ensuring that the path through the atmosphere taken by the high power beam is the same as that taken by the wavefront sensor and that the correction applied to the shared atmospheric path is optimal for the high-power beam. The high-power laser beam is directed up towards the Telescope 220 by two Relay Mirrors 304 and 306. The low-power beam is directed down by a First Corner Cube 312 and a Second Telescope 314. A First Beamsplitter 316 splits the LRF and Track Illuminator 250 optical path from the alignment path and target loop. A Second Beamsplitter 318 splits the LL Alignment Sensor 262 path from the target loop. A Third Beamsplitter 319 sends the target loop signal to the Target Track Sensor 260 and the Target Loop Aberration Sensor 270. A Second Corner Cube 266 directs the alignment signal to the Transfer Alignment System 264.

In, addition, one or more fast steering mirrors may be used to compensate for atmospheric tilts and reduce misalignment errors in the internal beam path caused by structural compliance, gimbal bearing runout, gimbal axis non-orthogonality, and base motion disturbances (coupled through stiction/friction in the gimbal bearings). In the illustrative embodiment, two fast steering mirrors are shown: a Target Loop Fast Steering Mirror 292 to provide high-bandwidth line-of-sight correction and a Local Loop Fast Steering Mirror 294 to align the laser 290.

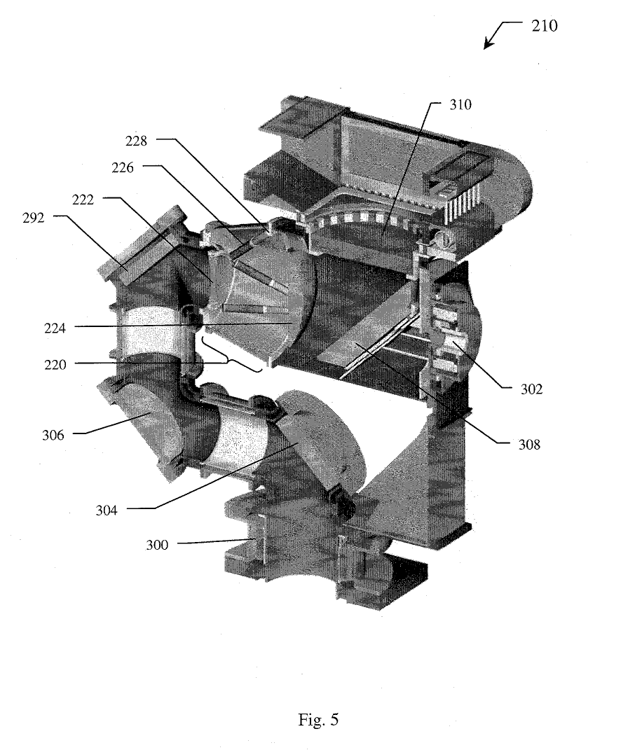

FIG. 5 provides a cut away view of the beam director gimbal 210 showing the optical elements along the beam path including an articulated secondary lens element 222 in accordance with the teachings of the present invention. The beam director 210 includes a Beam Director Telescope 220 and a 2-axis (azimuth, elevation) Coarse Gimbal. Shown in FIG. 5 are an Azimuth Torque Motor 300 and an Elevation Torque Motor 302. The laser beam is directed along the optical path by two Relay Mirrors 304 and 306, the Target Loop Fast Steering Mirror 292, the Telescope 220, and a Coelostat Mirror 308, and output through an Output Aperture 310. The Beam Director Telescope 220 includes a Primary Lens 224 and a Secondary Lens 222. For a high power laser, the Primary Lens 224 is typically bi-convex and the Secondary Lens 222 is typically bi-concave. Powered reflective elements (mirrors), diffractive optical elements, and combinations of reflective, refractive and diffractive elements may also be used in conjunction with or in place of the Primary Lens 224 and Secondary Lens 222 elements without departing from the spirit and/or scope of the present invention.

In accordance with the teachings of the present invention, low-order aberration correction is performed by articulating the Secondary Lens 222 of the Beam Director Telescope 220 in at least 5 degrees-of-freedom (axial displace, two tilts, and two decenters of the lens). In the preferred embodiment, the Secondary Lens 222 is moved relative to a fixed Primary Lens 224. Alternatively, the Primary Lens 224 can be moved relative to a fixed Secondary Lens 222, or both lenses can be moved, without departing from the scope of the present teachings.

In the illustrative embodiment, the Secondary Lens element 222 is articulated using six piezoelectrically-driven Linear Actuator Struts 226 arranged in a non-redundant “hexapod” configuration. These Linear Actuator Struts 226, which can change their length independently depending on their drive voltages, maneuver the Secondary Lens 222 in piston, translation, and tilt. This permits correction of the Zernike-described aberration orders of focus, coma, and to a lesser extent, astigmatism.

The hexapod arrangement of Linear Actuator Struts 226 is clearly shown in FIG. 5 (three of the six Linear Actuator Struts 226 are clearly shown). In this design, three pairs of Linear Actuator Struts 226 are mounted to three fixed mounting locations 228 on the beam director structure and alternate pairs of the same six Linear Actuator Struts 226 are mounted to three locations along the mounting ring of the Secondary Lens 222. Each end of the Linear Actuator Struts 226 is mounted so that it can pivot freely in its bearing, which may be a ball-in-socket or other bearing type with the same 2 degrees-of-freedom (pitch and yaw relative to strut centerline). An Adaptive Optics Processor 320 (shown in FIG. 3), responsive to the Target Loop Aberration Sensor 270, provides commands to the linear actuator associated with each Linear Actuator Strut 226, causing it to change in length, thereby moving the lens 222 to a prescribed orientation and position (5 degrees-of-freedom).

The adaptive optics processing is based on techniques well known to those of ordinary skill in the art. The Adaptive Optics Processor 320 can be implemented either in software running on a microprocessor, or in hardware.

The process of correcting low-order wavefront errors by rigid motions of an optical element begins with a derivative matrix. Each entry in this matrix is just the amount that a given aberration mode changes for a given change in a one of the optical element's positional degrees-of-freedom. These derivatives are typically calculated from a ray trace model and then later verified empirically using the hardware. Methods for calculating these derivatives are well known to those of ordinary skill in the art.

For example, certain motions mᵢ will produce certain aberrations zᵢ. One can calculate derivatives such as

$$\frac{Δ {z}_{i}}{Δ {m}_{i}} ,$$

and its inverse

$$\frac{Δ {m}_{i}}{Δ {z}_{i}} .$$

If the motions mᵢ are known, the following equation can be used to predict the resulting aberrations zᵢ:

$$\vert \begin{matrix}{m}_{1} \\ {m}_{2} \\ ⋮ \\ ⋮ \\ {m}_{M}\end{matrix} \vert \times \vert \begin{matrix}\frac{Δ {z}_{1}}{Δ {m}_{1}} & \frac{Δ {z}_{1}}{Δ {m}_{2}} & ⋮ & ⋮ & \frac{Δ {z}_{1}}{Δ {m}_{M}} \\ \frac{Δ {z}_{2}}{Δ {m}_{1}} & \frac{Δ {z}_{2}}{Δ {m}_{2}} & ⋮ & ⋮ & ⋮ \\ ⋮ & ⋮ & ⋮ & ⋮ & ⋮ \\ ⋮ & ⋮ & ⋮ & ⋮ & ⋮ \\ \frac{Δ {z}_{Z}}{Δ {m}_{1}} & ⋮ & ⋮ & ⋮ & \frac{Δ {z}_{Z}}{Δ {m}_{M}}\end{matrix} \vert = \vert \begin{matrix}{z}_{1} \\ {z}_{2} \\ ⋮ \\ ⋮ \\ {z}_{Z}\end{matrix} \vert \qquad [ 1 ]$$

where M is the total number of motions and Z is the total number of aberrations. In matrix notation, this equation is written as MD=Z, where D is the derivative matrix.

If the aberrations are known, the following equation can be used to predict the causing/correcting motions:

$$\vert \begin{matrix}{z}_{1} \\ {z}_{2} \\ ⋮ \\ ⋮ \\ {z}_{Z}\end{matrix} \vert \times \vert \begin{matrix}\frac{Δ {m}_{1}}{Δ {z}_{1}} & \frac{Δ {m}_{1}}{Δ {z}_{2}} & ⋮ & ⋮ & \frac{Δ {m}_{1}}{Δ {z}_{Z}} \\ \frac{Δ {m}_{2}}{Δ {z}_{1}} & \frac{Δ {m}_{2}}{Δ {z}_{2}} & ⋮ & ⋮ & ⋮ \\ ⋮ & ⋮ & ⋮ & ⋮ & ⋮ \\ ⋮ & ⋮ & ⋮ & ⋮ & ⋮ \\ \frac{Δ {m}_{M}}{Δ {z}_{1}} & ⋮ & ⋮ & ⋮ & \frac{Δ {m}_{M}}{Δ {z}_{Z}}\end{matrix} \vert = \vert \begin{matrix}{m}_{1} \\ {m}_{2} \\ ⋮ \\ ⋮ \\ {m}_{M}\end{matrix} \vert \qquad [ 2 ]$$

In matrix notation, this equation is written as ZD⁻¹=M, where D⁻¹ is the inverse of matrix D.

For 5 rigid body degrees-of-freedom (axial displacement, two tilts, and two decenters of the lens or mirror) and 10 aberration modes (Zernike terms up through the third-order), the derivative (or inverse derivative) matrix has 50 entries.

When a measure is made of the current phase errors along the HEL path using one of the several types of Wavefront Sensors 270 illustrated in FIG. 3, the aberration coefficients that are determined can be thought of as a column vector. Using either a matrix inversion process or optimal estimator (least squares fit), the derivative matrix is simply used to determine the best combination of rigid body motions necessary to correct the current phase errors. These corrective motions are implemented in the optical train by use of the hexapod Linear Actuator Struts 226 shown in FIG. 3, and the improvement in the wavefront error along the optical train is again measured by the Wavefront Sensor 270. This measurement, estimation, and implementation cycle repeats at the desired bandwidth consistent with the bandwidth of the perturbing sources (atmospheric behavior, base disturbances, etc.).

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A system for effecting low-order aberration correction of a beam of electromagnetic energy comprising:
first means for receiving and correcting the beam, said first means including at least one articulated optical element;
second means for generating a signal indicative of the aberrations to be corrected; and
third means, responsive to said second means, for adjusting the position of said optical element to generate an output beam that is at least partially compensated with respect to the aberrations.

2. The invention of claim 1 wherein the electromagnetic energy is optical energy.

3. The invention of claim 2 wherein said optical energy is a laser.

4. The invention of claim 1 wherein said aberration is caused by atmospheric turbulence.

5. The invention of claim 1 wherein said first means is a telescope comprising a primary lens or mirror and a secondary lens or mirror.

6. The invention of claim 5 wherein said primary lens or mirror is fixed in position and said secondary lens or mirror is articulated.

7. The invention of claim 1 wherein said third means adjusts the position of said optical element in at least five degrees-of-freedom.

8. The invention of claim 7 wherein three of said degrees-of-freedom are translation along first, second and third axes.

9. The invention of claim 8 wherein two of said degrees-of-freedom are rotation about two of said axes which are substantially perpendicular to the propagation axis of said beam of electromagnetic energy.

10. The invention of claim 1 wherein said third means includes a processor responsive to said second means for providing a correction signal.

11. The invention of claim 10 wherein said third means further includes a predetermined number of linear actuator struts attached to said optical element.

12. The invention of claim 11 wherein said linear actuator struts change their lengths in response to said correction signal to maneuver said optical element in axial displacement, translation perpendicular to the propagation axis of said beam of electromagnetic energy and, and tilt about axes which are substantially perpendicular to the propagation axis of said beam.

13. The invention of claim 11 wherein said predetermined number is six.

14. The invention of claim 13 wherein said linear actuator struts are arranged in a non-redundant hexapod configuration.

15. The invention of claim 14 wherein three pairs of said linear actuator struts are mounted to three fixed mounting locations.

16. The invention of claim 15 wherein alternate pairs of the six linear actuator struts are mounted to three locations along the optical element.

17. The invention of claim 11 wherein each linear actuator strut is mounted so it can pivot freely in its bearing.

18. The invention of claim 11 wherein said linear actuator struts are piezoelectrically driven.

19. The invention of claim 1 wherein said second means includes fourth means for detecting aberrations in said received beam.

20. The invention of claim 19 wherein the fourth means includes a wavefront error sensor.

21. A beam control architecture comprising:
a telescope for receiving and correcting a beam of electromagnetic energy, said telescope including at least one articulated optical element;
a wavefront error sensor for detecting aberrations in said beam and adapted to provide a wavefront error signal in response thereto;
a processor adapted to provide a correction signal in response to the wavefront error signal; and
a predetermined number of linear actuator struts attached to said optical element to maneuver it in piston, translation, and tilt in response to said correction signal to generate an output beam that is at least partially compensated with respect to the aberrations.

22. A method for effecting low-order aberration correction of a beam of electromagnetic energy including the steps of:
receiving the beam using at least one articulated optical element;
generating a signal indicative of the aberrations to be corrected; and
adjusting the position of said optical element in response to said signal to generate an output beam that is at least partially compensated with respect to the aberrations.
